(19) United States
(12) Patent Application Publication
(10) Pub. No.: US 2006/0059194 A1
(43) Pub. Date: Mar. 16, 2006

(54) Method and apparatus for retrieving rights object from portable storage device using object identifier

(75) Inventors: Yun-sang Oh, Seoul (KR); Sang-sin Jung, Seoul (KR); Moon-sang Kwon, Seoul (KR); Kyung-im Jung, Seongnam (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/222,847

(22) Filed: Sep. 12, 2005

(30) Foreign Application Priority Data
Sep. 15, 2004 (KR) 10-2004-0073816

(51) Int. Cl. G06F 17/00

(52) U.S. Cl. 707/103 R

(57) ABSTRACT

A method and an apparatus for retrieving a rights object from a portable storage device using an object identifier are provided. The method includes: allowing a host device to have access to a portable storage device; allowing the host device to read an object identifier stored in the portable storage device; allowing the host device to store the read object identifier; and allowing the host device to retrieve the stored object identifier so as to perform a job on an object stored in the portable storage device.

### CROSS-REFERENCE TO RELATED APPLICATION

This application claims priority from Korean Patent Application No. 10-2004-0073816 filed on Sep. 15, 2004 in the Korean Intellectual Property Office, the disclosure of which is incorporated herein by reference in its entirety.

### BACKGROUND OF THE INVENTION

1. Field of the Invention

Methods and apparatuses consistent with the present invention relate to retrieving a rights object from a portable storage device by using an object identifier.

2. Description of the Related Art

Recently, thanks to vigorous studies of digital rights management (DRM), commercial services employing the DRM have been introduced or are being introduced. The reason for introduction of the DRM can be derived from various features of digital content. Unlike analog data, digital content can be copied without loss, and can be easily reused, processed, and distributed. The production of digital content, however, requires significant cost, labor, and time. Therefore, when piracy of the digital content is permitted, a producer's profits from the digital content are lost. As a result, the producer's eagerness to produce digital content is frustrated. Thus, piracy hinders the practical advancement in digital content industries.

In the past, an effort was made to protect digital content, but was primarily based on inhibiting access to the digital content without permission. Accordingly, only those persons having paid for access were permitted to access the digital content. However, if the persons having paid for access subsequently distributed the digital content to third parties, the third parties could utilize the digital content without paying. The concept of DRM was introduced to solve such a problem. The DRM permits any one to have access to encrypted digital content without any restriction but requires licenses, such as rights objects, for decoding and executing the encrypted digital content. Therefore, by using the DRM, it is possible to protect digital content more effectively.

Portable storage devices are devices which can be attached to a variety of digital devices (e.g., a mobile phone, a computer, and a digital camera), can store data, can be detached from the digital devices, and can be easily carried on the move. The portable storage devices generally include a storage space for storing data and a unit for operation and control. A multimedia card (MMC), as an exemplary portable storage device, overcomes limitations of conventional hard disks or compact disks and is operable to store multimedia data, so that the MMC can be used with various kinds of digital devices. The MMC has an operation unit which is not provided in the conventional storage devices. Therefore, in addition to storing data, the MMC can also perform control, and thus is suitable for storing a variety of multimedia data. Recently, a secure multimedia card (Secure MMC), having a security function added thereto, was developed. The Secure MMC can execute the function of security and protect copyrights in storing, transmitting, and receiving the digital content. Accordingly, management of copyrights for the digital content is possible in the storage devices and the digital devices. Hereinafter, the digital devices, such as a digital camera, a mobile phone, a computer, a digital camcorder, etc., are all referred to as “host devices.”

Memory cards, such as flash memories, have been a primary source of portable storage devices. Such memory cards have an advantage in that data can be conserved without a supply of power, unlike dynamic random access memory (DRAM) or static random access memory (SRAM). However, memory cards have a disadvantage in that a speed of inputting data thereto and outputting data therefrom is slower than that of DRAM.

Rights objects, which are stored in the portable storage devices, are data that is always referred to at the time of reproduction of the digital content, which often requires multiple operations such as reading, writing, and correction. Therefore, in order to efficiently carry out such frequent operations, it is necessary to reduce the time for retrieving a specific rights object.

Korean Unexamined Patent Publication No. 10-2002-0020104 discloses a method of assigning a cache function to SRAM so as to enhance the input and output speed of a memory card. In the publication, if the memory card is coupled to a digital device, the SRAM is initialized and serves as a cache memory for storing specific data at the time of reading and writing operations, thereby enhancing the input and output speed of the memory card.

When the previously-retrieved data are retrieved again, the input and output speed can be enhanced, but the delay time resulting from retrieval of the data cannot be reduced.

Specifically, in a DRM system storing rights objects, since portable storage devices frequently perform input/output operations for a specific rights object and the operation of retrieving the respective rights objects with a variety of retrieval conditions, there is a need to enhance the input and output speed and the retrieval speed.

### SUMMARY OF THE INVENTION

An aspect of the present invention makes it possible to rapidly retrieve an object stored in a portable storage device and to increase the speed for using the object.

Another aspect of the present invention obtains a position of the object stored in the portable storage device by using object identifier information.

Another aspect of the present invention provides a method of securely managing the object identifier information by using a cryptographic hash function employing a key.

Methods and apparatuses consistent with the present invention retrieve a rights object from a portable storage device by using an object identifier.

According to an aspect of the present invention, there is provided a method of retrieving a rights object from a portable storage device using an object identifier, the method comprising: allowing a host device to access a portable storage device; allowing the host device to read an object identifier stored in the portable storage device; allowing the host device to store the object identifier; and allowing the host device to retrieve the stored object identifier so as to perform a job on an object stored in the portable storage device.

According to another aspect of the present invention, there is provided a method of retrieving a rights object from a portable storage device by using an object identifier, the method comprising: allowing a portable storage device to access a host device; allowing the portable storage device to transmit object identifier information, which is stored in advance in the portable storage device, to the host device; allowing the portable storage device to receive from the host device position information on an object and information on a job to be performed on the object; and allowing the portable storage device to access the object and information on the object by using the received position information on the object.

According to another aspect of the present invention, there is provided an apparatus for retrieving a rights object from a portable storage device using an object identifier, the apparatus comprising: an object identifier storage unit which stores the object identifier; and an application unit which reads the object identifier stored in the portable storage device and stores the object identifier in the object identifier storage unit, wherein the application unit retrieves the object identifier from the object identifier storage unit and acquires position information on an object stored in the portable storage device, so as to perform a job on the object.

According to another aspect of the present invention, there is provided a portable storage device comprising: an object information storage unit which stores an object and object identifier information; and an application unit which transmits an object identifier to a host device and receives position information on the object and information on a job to be performed on the object from the host device, wherein the application unit directly accesses the object information storage unit by using the position information.

### BRIEF DESCRIPTION OF THE DRAWINGS

The above and other aspects of the present invention will become more apparent by describing in detail exemplary embodiments thereof with reference to the attached drawings in which:

FIG. 1 is a diagram illustrating a procedure of mutual authentication according to an exemplary embodiment of the present invention;

FIG. 2 is a block diagram illustrating structures and interactions of a host device and a portable storage device according to an exemplary embodiment of the present invention;

FIG. 3 is a block diagram illustrating an object table according to an exemplary embodiment of the present invention;

FIG. 4 is a block diagram illustrating an object identifier table according to an exemplary embodiment of the present invention;

FIG. 5 is a block diagram illustrating a process in which the host device creates an object identifier table according to an exemplary embodiment of the present invention;

FIG. 6 is a block diagram illustrating a process in which the host device reads out an object from the portable storage device according to an exemplary embodiment of the present invention;

FIG. 7 is a block diagram illustrating a process in which the host device corrects the object read from the portable storage device according to an exemplary embodiment of the present invention;

FIG. 8 is a block diagram illustrating a process in which the host device stores an object in the portable storage device according to an exemplary embodiment of the present invention;

FIG. 9 is a block diagram illustrating a process in which the host device deletes an object stored in the portable storage device according to an exemplary embodiment of the present invention; and

FIG. 10 is a table illustrating examples of objects and object identifiers stored in the object table.

### DETAILED DESCRIPTION OF THE EXEMPLARY EMBODIMENTS

Now, terms used herein are defined as follows.

Host Device

A host device means a device which is coupled to a portable storage device to acquire a rights object stored in the portable storage device. Examples of the host device include portable multimedia devices such as a mobile phone, a personal digital assistant (PDA), etc. and non-portable multimedia devices such as a computer, a digital television, etc. The host device may be generally referred to as a “device” or a “host.”

Portable Storage Device

A portable storage device means a storage device which includes a readable, writable, and erasable non-volatile memory such as a flash memory and which can be connected to a host device. Examples of such a portable storage device may include a smart media, a memory stick, a CompactFlash (a registered trademark of Sandisk Corp.) (CF) card, an XD-picture card (a registered trademark of Fuji Photo Film Co., Ltd.), a multimedia card, a universal serial bus (USB) storage device, etc. As an exemplary portable storage device, a secure multimedia card (Secure MMC) is primarily described herein.

Rights Object and Object

A rights object is an object which has content of rights to a digital production and which establishes authority on reproduction, display, execution, printing, export (copy and transfer), perusal, etc. of the digital production. The rights object has information on whether the authority on the content has been established and is used to perform digital rights management (DRM) between a host device and a portable storage device. An object denotes data which can be read by both of a host application and a storage application, and may mean the rights object or one of a plurality of parts into which the rights object is divided. When the rights object is large in size, the rights object can be divided into parts in a specific format and managed.

Object Information Storage Unit

An object information storage unit is provided in a portable storage device and stores an object along with identifier information for searching out the object. The object information storage unit may include information on a position where the object is stored. The object information storage unit can store the object information in various formats, and in an exemplary embodiment of the present invention, the object information storage unit can store the object information in a table format. An object table described herein is an example of the object information storage unit, but the present invention is not limited to the object table.

The object table can comprise, for example, an object and information on the object including position information, identifier information, Meta information, etc. The position information on the object denotes information on the position where the object is stored. It is possible to perform jobs such as reading and writing the object stored in the portable storage device using the position information.

The Meta information includes status information required for storing the object.

The object information storage unit may include an object mapping table, which stores statuses of the objects stored in the object table.

Object Identifier

An object identifier serves as a reference for retrieving and identifying an object. A plurality of identifiers may exist for one object. For example, where an object stores specific content, a content identifier may serve as the identifier for identifying the corresponding object. A name of a content producer or an identifier of the producer may serve as an identifier for identifying the object. In addition, the object identifier may include information on whether the corresponding object provides authority on reproduction of the corresponding content or authority to copy or transfer the corresponding content. Information on a time period to use the object may be used as an identifier to retrieve an object based on whether a time period of use of the object has elapsed. The object identifier is intended to retrieve an object corresponding to a desired condition without checking the object and denotes information required for retrieving the object. Accordingly, the object identifier can be defined in a variety of ways. A rights object identifier given to the respective objects may serve as an identifier for the corresponding object.

Object Identifier Storage Unit

An object identifier storage unit stores the above-mentioned object identifiers and is used in a case where the host device, to use rights objects stored in the portable storage device, stores the object identifiers. In an exemplary embodiment of the present invention, the object identifier storage unit stores the object identifiers in a table format. The object identifier table described herein is an example of the object identifier storage unit, but the present invention is not limited to this example. The object identifier table is created through an interaction between the host device and the portable storage device. The object identifier table may include position information on objects.

Object Mapping Information Storage Unit

An object mapping information storage unit stores statuses of objects stored in the object information storage unit. For example, the object mapping information storage unit may store object mapping information as a series of bits for showing only whether the objects are stored or the object mapping information may be embodied in a table for storing more information. In an exemplary embodiment of the present invention, the object mapping information is stored in a table format, but the present invention is not limited to this exemplary embodiment. Hereinafter, the object mapping information storage unit is referred to as an “object mapping table.”

Connection Between Host Device and Portable Storage Device

A host device and a portable storage device are coupled to each other by wire or a wireless medium. Therefore, the connection between the host device and the portable storage device includes the wireless medium. That is, the host device and the portable storage device can receive data from and transmit data to each other by wire or the wireless medium, and the connection between the host device and the portable storage device is not meant to be limited to a physical coupling in which they are attached or combined to each other.

On the other hand, terms such as “unit,” “module,” and “table,” as used herein, may denote software elements or hardware elements such as a field programmable gate array (FPGA) or an application specific integrated circuit (ASIC), with the “units” or “modules” performing specific functions. The “units” and “modules” are not limited to software or hardware. The “units” or “modules” may be provided in a storage medium and may be provided to reconstruct one or more processors. Therefore, the “units” and “modules” may include elements such as software elements, object-oriented software elements, class elements, and task elements, and processes, functions, attributes, procedures, sub-routines, segments of program codes, drivers, firmware, micro codes, circuits, data, databases, data structures, tables, arrays, and variables. The functions of the elements and the “units” or “modules” may be coupled into a smaller number of elements and “units” or “modules,” or may be further divided into additional elements and “units” or “modules.” In addition, the elements and the “units” or “modules” may be used to reconstruct one or more central processing units (CPUs) in a device or a secure multimedia card.

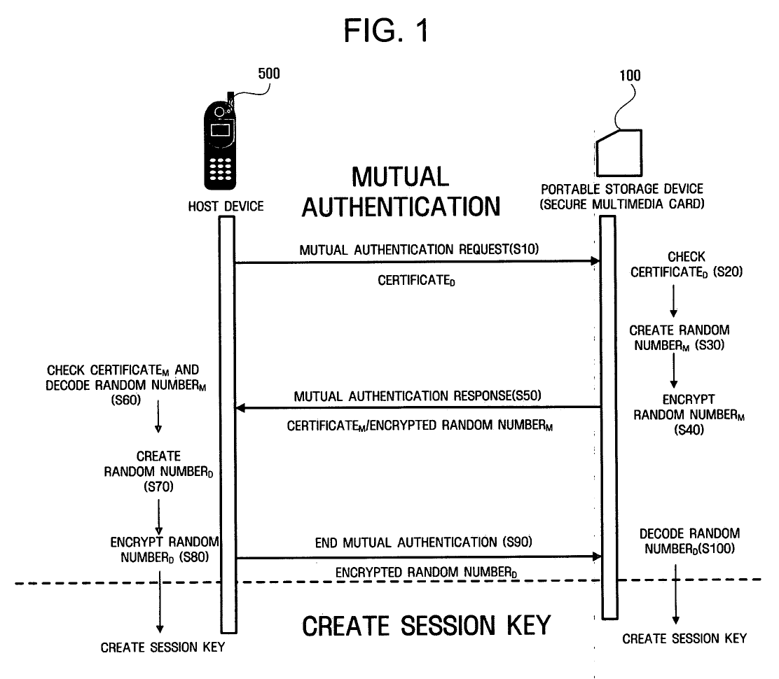

FIG. 1 is a diagram illustrating a procedure of mutual authentication according to an exemplary embodiment of the present invention. The authentication procedure is described using a secure multimedia card 100 as an example of a portable storage device in FIG. 1. The procedure of mutual authentication is a procedure of mutually confirming that a host device 500 and the secure multimedia card 100 are valid devices and exchanging random numbers for creating a session key between both devices. A session key can be created using the random numbers obtained through the procedure of mutual authentication. In FIG. 1, the description above an arrow indicates an instruction requesting the counter device for a specific action and the description below an arrow indicates parameters corresponding to the instruction or data to be transferred. In an exemplary embodiment, all the instructions in the procedure of mutual authentication are given by the host device 500, and the secure multimedia card 100 carries out actions in response to the instructions. For example, when the host device 500 sends an instruction MUTUAL AUTHENTICATION RESPONSE S50 to the secure multimedia card 100, the secure multimedia card 100 receiving the instruction sends CERTIFICATE_{M} and ENCRYPTED RANDOM NUMBER_{M} to the host device 500. In another exemplary embodiment, instructions can be given by both the host device 500 and the secure multimedia card 100. In this case, the secure multimedia card 100 can send MUTUAL AUTHENTICATION RESPONSE S50 along with CERTIFICATE_{M} and ENCRYPTED RANDOM NUMBER_{M} to the host device 500. The procedure of mutual authentication, as illustrated in FIG. 1, will now be described in detail.

First, the host device 500 requests the secure multimedia card 100 for mutual authentication (S10). Along with the request for mutual authentication, the host device 500 sends a host device public key PubKey_{D} of the host device 500 to the secure multimedia card 100. In an exemplary embodiment, the host device public key PubKey_{D} in operation S10 is transmitted to the secure multimedia card 100 using a host device certificate Certificate_{D} issued to the host device 500 by a certification authority. The host device certificate Certificate_{D} includes a host device ID, the host device public key PubKey_{D} and an electronic signature of the certification authority. The secure multimedia card 100 receiving the host device certificate Certificate_{D} can check whether the host device 500 is a valid device, and can acquire the host device public key PubKey_{D} from the host device certificate Certificate_{D}.

The secure multimedia card 100 checks whether the host device certificate Certificate_{D} is valid using a certificate revocation list (CRL) (S20). When the host device certificate Certificate_{D} is a certificate of a host device registered in the CRL, the secure multimedia card 100 can reject the mutual authentication with the host device 500. When the host device certificate Certificate_{D} is a certificate of a host device not registered in the CRL, the secure multimedia card 100 acquires the host device public key PubKey_{D} using the host device certificate Certificate_{D}.

Then, the secure multimedia card 100 creates RANDOM NUMBER_{M} (S30). The created RANDOM NUMBER_{M} is encrypted with the host device public key PubKey_{D} (S40). The secure multimedia card 100 sends the instruction of mutual authentication response to the host device 500, thereby completing the procedure of the mutual authentication response (S50). In the mutual authentication response, the secure multimedia card 100 sends a secure multimedia public key PubKey_{M} and the encrypted random number ENCRYPTED RANDOM NUMBER_{M} to the host device 500. In an exemplary embodiment, instead of the secure multimedia card public key PubKey_{M}, a secure multimedia card certificate Certificate_{M} may be sent. In another exemplary embodiment, the secure multimedia card 100 may send an electronic signature Signature_{M} of the secure multimedia card 100 to the host device 500 along with the secure multimedia card certificate Certificate_{M} and the encrypted random number ENCRYPTED RANDOM NUMBER_{M}.

The host device 500 receives the secure multimedia card certificate Certificate_{M} and the encrypted random number ENCRYPTED RANDOM NUMBER_{M}, checks whether the secure multimedia card 100 is valid through confirmation of the certificate Certificate_{M}, acquires the secure multimedia card public key PubKey_{M}, and decodes the encrypted random number ENCRYPTED RANDOM NUMBER_{M} with a host device private key PrivKey_{D} to acquire the random number RANDOM NUMBER_{M} (S60). Then, the host device 500 creates a random number RANDOM NUMBER_{D} (S70). The created random number RANDOM NUMBER_{D} is encrypted with the secure multimedia card public key PubKey_{M} (S80). Then, the mutual authentication ending process is performed (S90). In the mutual authentication ending process, the host device 500 transmits the encrypted random number ENCRYPTED RANDOM NUMBER_{D} to the secure multimedia card 100. In an exemplary embodiment, the host device 500 can send an electronic signature Signature_{D} of the host device 500 to the secure multimedia card 100 along with the encrypted random number ENCRYPTED RANDOM NUMBER_{D}.

The secure multimedia card 100 decodes the encrypted random number ENCRYPTED RANDOM NUMBER_{D} using a secure multimedia card private key PrivKey_{M} (S100). Accordingly, the host device 500 and the secure multimedia card 100 can acquire random numbers created by both devices. In an exemplary embodiment, since both the host device 500 and the secure multimedia card 100 create and use the random numbers, overall randomness is greatly enhanced and thus secure mutual authentication is possible. That is, even if the randomness is weak at any one party, the other party can compensate for the weak randomness.

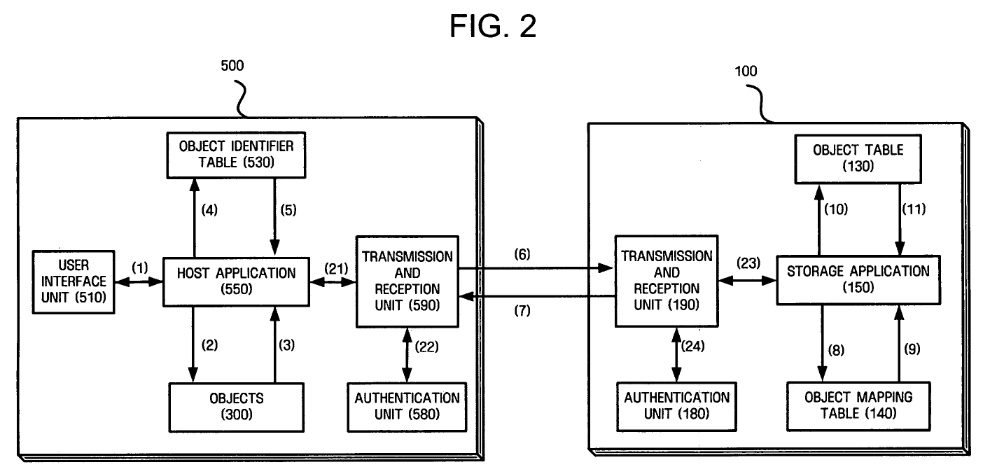

FIG. 2 is a block diagram illustrating structures and interactions of the host device 500 and the portable storage device 100 according to an exemplary embodiment of the present invention.

Here, the host device 500 and the portable storage device 100 are coupled to each other. The coupling is not limited to a coupling by wire, but includes a wireless coupling as well.

The host device 500 has a user interface unit 510 for input and output by a user. The user can request reproduction, transfer, etc. of specific content using the user interface unit 510. In this case, information on reproduction and transfer of a rights object can be required. A host application 550 utilizes objects 300 stored in the host device 500 or object identifiers stored in an object identifier table 530, or requests the portable storage device 100 for the information on the rights object. A transmission and reception unit 590 transmits and receives data with respect to the portable storage device 100. An authentication unit 580 performs the authentication procedure shown in FIG. 1 and encrypts or decodes the data.

The portable storage device 100 comprises a storage application 150, an object mapping table 140, and an object table 130.

The storage application 150 reads or writes an object in response to the request from the host device 500. A transmission and reception unit 190 transmits and receives data with respect to the host device 500. An authentication unit 180 performs the authentication procedure shown in FIG. 1 and encrypts or decodes the data.

The host device 500 and the portable storage device 100 shown in FIG. 2 operate as follows.

When the host device 500 and the portable storage device 100 are coupled to each other, the authentication procedure shown in FIG. 1 is carried out by the authentication units 580 and 180 in the respective devices.

When the authentication procedure is ended, the host device 500 and the portable storage device 100 encrypt data to be transmitted or decrypt data that is received by using the session key created in the authentication procedure ((22) and (24)). Then, the host application 550 and the storage application 150 mutually transmit and receive data through the transmission and reception units 590 and 190, respectively ((21) and (23)).

The user interface unit 510 requests the host application 550 to perform a specific job (1).

Accordingly, the host application 550 performs jobs such as the reading and writing of an object.

The host application 550 should check whether the object exists in the host device 500 or in the portable storage device 100 before attempting to retrieve the object.

The host application 550 may store the object and perform, for example, writing, correction, deletion, and reading of the object ((2) and (3)). The host application 550 is an application running in the host device 500. One or more host applications may require the objects stored in the portable storage device 100 simultaneously or sequentially.

In order to acquire information on an object which does not exist in the host device 500, the host application 550 can request the portable storage device 100 for information on the object ((6) and (7)) or read the information by using the object identifier table 530 ((4) and (5)).

In order to search for the information requested from the host application 550 or perform the job requested therefrom, the storage application 150 can write, store, correct, delete, or read the information on the object with respect to the object mapping table 140 ((8) and (9)). Alternatively, the storage application 150 may read, write, correct, or delete the objects or the object identifiers stored in the object table 130 ((10) and (11)).

If the host device 500 has the object identifier table 530, the host application 550 can easily find out a position of a desired object. If the host device 500 does not have the object identifier table 530, the host application 550 can request the portable storage device 100 for the object identifier table 530.

The object identifier table 530 enables easy retrieval of an object from the object table 130, and enables easy input and output of the object.

The information transmitted and received between the host application 550 and the storage application 150 shown in FIG. 2 can be encrypted with the session key created in the authentication procedure shown in FIG. 1 and then be transmitted.

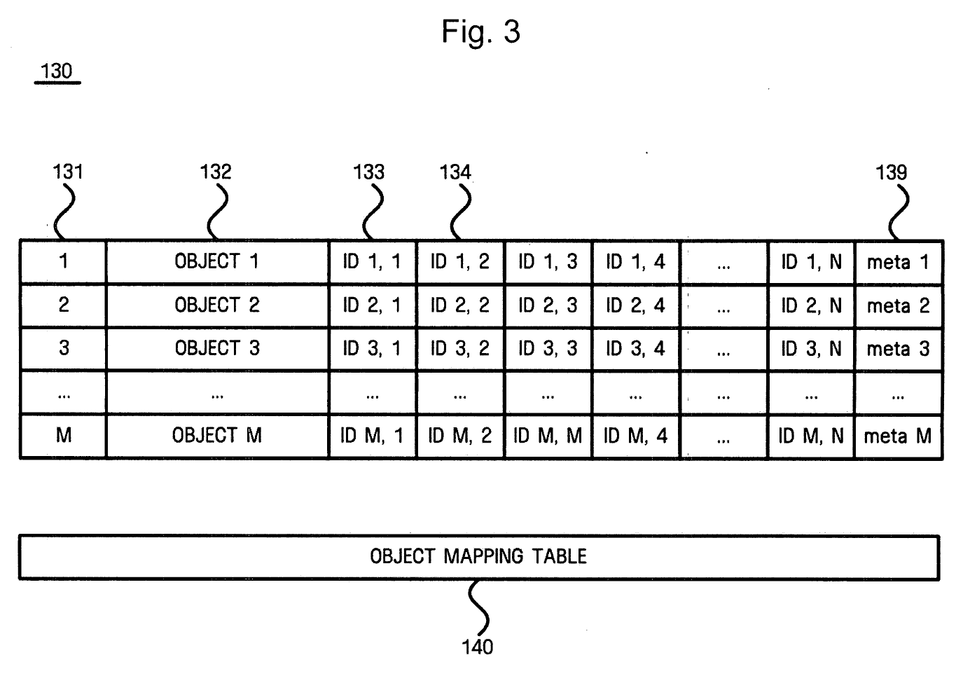

FIG. 3 is a block diagram illustrating an object table according to an exemplary embodiment of the present invention. The object table 130 includes objects and object identifiers required for identifying the objects. The object table 130 can further include position information on the objects. The object identifiers of the object table 130 can serve as a key for retrieving the objects. For example, the object identifiers can include a content identifier indicating what the content relating to the corresponding object is, a content provider identifier indicating who the provider of the content relating to the corresponding object is, a rights object identifier of the corresponding object, etc. In addition, the object identifiers can have additional information on the objects. The objects can be retrieved using the object identifiers.

For example, the object identifiers can include an identifier indicating authority for reproduction, an identifier indicating authority for transfer, etc. so as to indicate what authority an object has. The period of time when the corresponding object can be utilized may be used as an identifier. When such identifier information is abundant, the host application 550 can retrieve the objects by using the object identifier information without access to the information on the objects.

A Meta information field 139 includes information on whether data are stored, corrected, or deleted with respect to the corresponding object.

In addition, the portable storage device 100 may have an object mapping table 140 so as to check whether data of the object table 130 are corrected.

The object table 130 includes, for example, the objects and the identifiers of the objects, but the objects are not necessarily stored in a continuous format. An object may be deleted. In this case, the object may be considered as being deleted using the object mapping table 140, instead of actually deleting the object, and then a new object may be stored at the position where the corresponding object is stored. The objects are stored in an object field 132 of the object table 130. For example, if the object stored at the fifth line in FIG. 3 is deleted for the reason of expiration of time, etc., the object at the fifth line in the table can be actually deleted. However, when the object is informed as being deleted using the object mapping table 140, the time for deleting the object and the identifiers thereof may be reduced. In addition, by checking whether the object properly exists by using the object mapping table 140 prior to attempting retrieval of the object, it is possible to remove the possibility of retrieving a deleted object.

Object position information 131 indicates a position where the corresponding object is stored, that is, an address. The object position information 131 may be omitted. If the objects have a constant length and the object identifiers thereof have a constant length by a hash function, the positions of the objects can be easily calculated. Therefore, the object position information is not necessarily required. The object identifiers can be stored using the hash function so as to have a constant length. For example, the hash function can be used so that the object identifiers in the first field 133 of FIG. 3 have 8 bytes and the object identifiers in the second field 134 have 7 bytes. Specifically, a cryptographic hash function can be used to transform certain information A into a hash value B having a specific length. At this time, the certain information A cannot be inferred only with the hash value B, and a value C which is not A but transformed into the same value B cannot be acquired only with A and B. A secure hash algorithm (SHA1), a message digest 4 (MD4) algorithm, and a message digest 5 (MD5) algorithm are examples of algorithms that can be used in employing the cryptographic hash function.

The object identifiers may also be stored, for example, using a cryptographic hash function employing a private key. In the cryptographic hash function employing a private key, input data m (which corresponds to an object identifier) and a private key k are used to create a hash value h(k,m).

When the cryptographic hash function employing a private key is used, a memory card can transfer a private key for the hash function to a host in the course of an authentication procedure between the host and the memory card. Accordingly, the host can utilize the contents of the object identifier table using the private key while the object identifier table exists in the host. On the other hand, when the authentication between the host and the memory card has ended, the host cannot acquire the private key of the memory card any more. Therefore, even when the object identifier table stored in a memory such as SRAM is not intentionally deleted, a malicious application of the host cannot acquire the private key. Accordingly, the malicious application can read the object identifier table but cannot understand the contents thereof.

When the authentication between the host and the memory card subsequently becomes valid, the host can use the existing object identifier table, without fetching the information for creating the object identifier table from the memory card. Therefore, when the cryptographic hash function employing a private key is used, the object identifier table can be managed in the host more securely. If the cryptographic hash function employing a private key is used, the portable storage device 100 stores the private key in a particular storage area, and the storage application 150 cryptographically hashes the object identifiers using the private key and stores the hashed object identifiers in the object table 130.

If the host device 500 requests the portable storage device 100 for the object identifier information, the storage application 150 securely encrypts the transformed object identifier information and the private key and then transmits the encrypted object identifier information and the private key to the host application 550. Then, the host application 550 stores the transformed object identifier information in the object identifier table 530 and securely stores the private key. The host application 550 uses the private key to have access to an object identifier. On the other hand, when the host device 500 and the portable storage device 100 are detached from each other, the private key stored in the host device 500 is deleted and a hashed value of a specific object identifier cannot be acquired. Therefore, the object identifier table 530 can be securely managed.

An object stored in FIG. 3 can indicate one rights object or a part of several divisions such as several assets. When one rights object is divided into several assets, the assets can be stored in the object table 130 and rights object identifiers and asset identifiers can be stored in the object identifier fields.

An object identifier may be a unique value which can distinguish a rights object from another rights object stored in the same device or a different device and a rights object to be created in the future. The length of an object identifier may be variable. At this time, taking it into consideration that the portable storage device 100 has a limited memory space, it is preferable, but not necessary, to reduce the lengths of the object identifiers to a constant. This process can be carried out using the cryptographic hash function or the cryptographic hash function employing a private key described above. In this case, it is possible to enhance the security of data.

In order to utilize the hashed object identifiers, an operation unit executing the hash function should be provided in the portable storage device 100 and the host device 500, and the host application 550 and the storage application 150 can perform such a function. For example, when a specific object identifier is intended to be retrieved from the host device 500, the host application 550 can transform the object identifier using the cryptographic hash function and can search the object identifier table 530 using the transformed value.

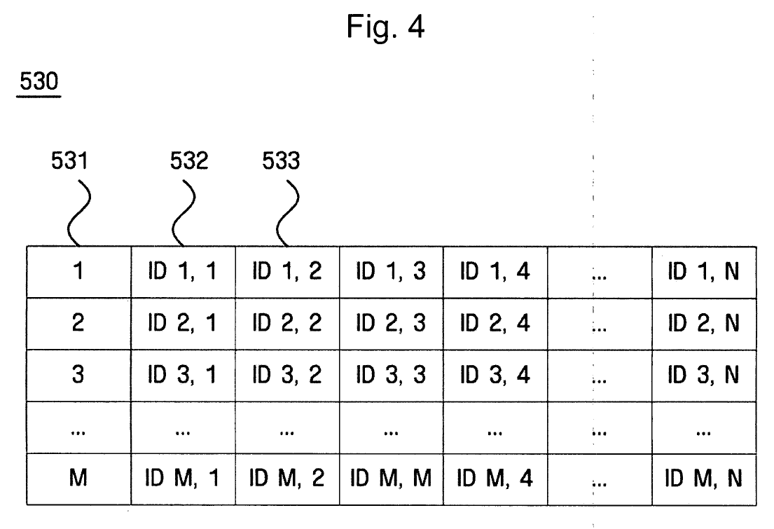

FIG. 4 is a block diagram illustrating an object identifier table according to an exemplary embodiment of the present invention.

The object identifier table 530 shown in FIG. 4 stores information on the object identifiers from the object table 130 of the portable storage device 100 and is provided in the host device 500.

Since the object identifier table 530 stores the object identifiers from the object table 130, the objects in the portable storage device 100 can be retrieved.

The object identifiers constituting the object identifier table 530 are the same as described above with reference to FIG. 3. The object position information 531 may be selectively included. If the lengths of the objects are set to a predetermined size, the positions of the objects can be easily calculated without the object position information 531. Object identifier fields 532 and 533 have identifier values according to specific items.

The host device 500 has the object identifier table 530 and may have a position information field of the objects. When the lengths of the objects are fixed constant and the object identifiers are stored in a fixed-size field through the cryptographic hash function described above, the positions of the objects in the portable storage device 100 can be easily calculated. Accordingly, the position information on the objects can be selectively included. If the portable storage device receives a request for a job relating to an object with the position information on the object, the retrieval time of the object can be reduced and thus the job can be executed more rapidly.

Since the portable storage device 100 has the object mapping table 140 shown in FIG. 3, the portable storage device 100 maintains the information indicating that the corresponding object is deleted or corrected, and thus can determine that the object is deleted, without retrieving the corresponding object. As a result, it is possible to enhance efficiency.

After the host device 500 and the portable storage device 100 authenticate each other, the host device 500 can request the portable storage device 100 for the object identifier table 530 shown in FIG. 4, or the portable storage device 100 can provide the object identifier table 530 to the host device 500.

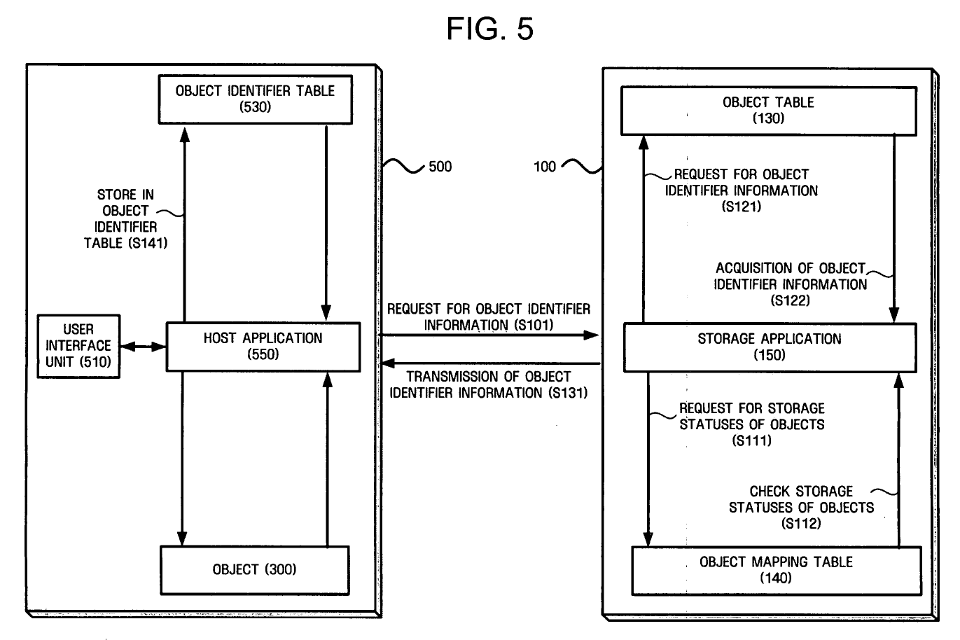

FIGS. 5 to 9 are block diagrams illustrating processes according to an exemplary embodiment of the present invention. For the purpose of convenient explanation, the transmission and reception units 190 and 590 and the authentication units 180 and 580 are omitted in the respective devices. Data transmitted from the host device 500 and the portable storage device 100 is encrypted by the authentication units 580 and 180, respectively, and thus the received data is decoded by the authentication units 580 and 180, respectively. The transmission and reception of data are performed respectively by the transmission and reception units 590 and 190 of the host device 500 and the portable storage device 100.

FIG. 5 is a block diagram illustrating a process of allowing the host device 500 to create the object identifier table 530 according to an exemplary embodiment of the present invention.

The host application 550 of the host device 500 requests the storage application 150 of the portable storage device 100 for the object identifier information (S101). The storage application 150 requests the object mapping table 140 for the storage statuses of the objects (S111), and checks the storage status of the objects (S112). This process is performed because an invalid object may exist in the object table 130 or an object not stored in the object table 130 may exist if the object is deleted, corrected, or written in the object table 130. For example, assuming that M objects exist in the object table and the objects are stored as M rows, the M rows may not necessarily be stored continuously. This situation can occur, for example, when an object is deleted or expires. Therefore, by performing the process of checking the storage statuses of the objects, it is possible to further enhance the retrieval speed.

The storage application 150, having checked the storage statuses of the objects, requests the object table 130 for the object identifier information (S121) and acquires the object identifier information from the object table 130 (S122). The acquired object identifier information is transmitted to the host application 550 (S131). The host application 550 stores the received object identifier information in the object identifier table 530 (S141). If the object identifier table does not exist, a new object identifier table can be created so that the received object identifier information is stored therein.

The request in operation S101 does not mean only the request from the host device 500. Operation S101 is selective, and when the host device 500 and the portable storage device 100 have access to each other by wire or a wireless medium, the host device 500 may automatically receive the object identifier information from the portable storage device 100.

This process may be performed until the host device 500 reads all of the object or a part thereof stored in the portable storage device 100.

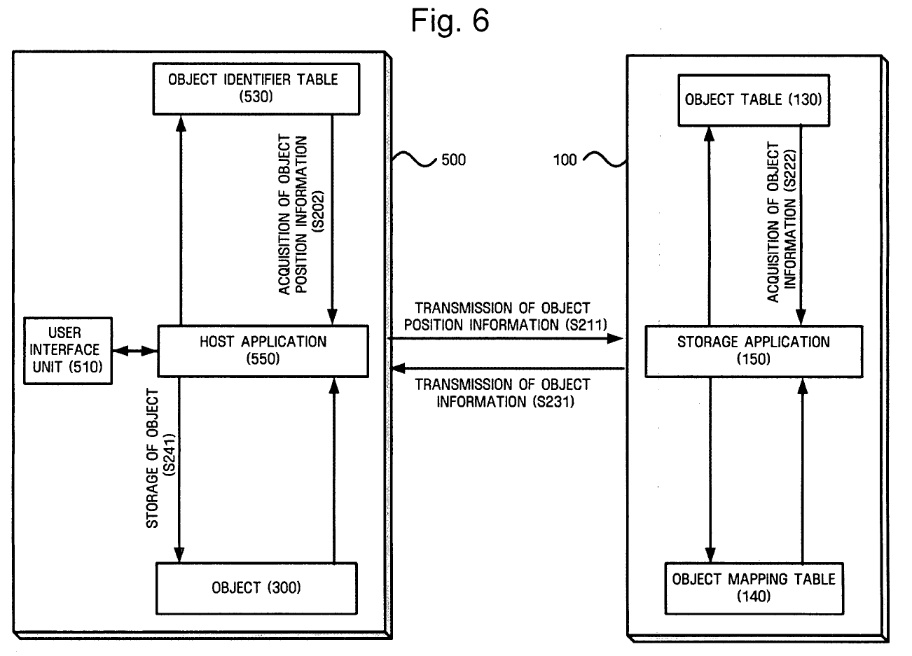

FIG. 6 is a block diagram illustrating a process of allowing the host device to read the objects from the portable storage device according to an exemplary embodiment of the present invention.

Before the host application 550 reads out the objects stored in the portable storage device 100 into the host device 500, the host application 550 first searches the object identifier table 530. The host application 550 searches the object identifier table 530 created, for example, as illustrated in the exemplary embodiment shown in FIG. 5 and thus acquires position information on a desired object (S202). The host application 550 transmits the position information on the object to the storage application 150 (S211). At this time, identifier information on the object can be transmitted as well. The storage application 150 directly acquires the information on the corresponding object by using the received position information on the object without searching the object table 130 (S222) and transmits the object information to the host application 550 (S231).

The host application 550 can reproduce content with the received object or store the object in a storage medium in the host device 500 (S241). The authorities provided by an object include, for example, copying, transferring, printing, etc., in addition to reproducing the content.

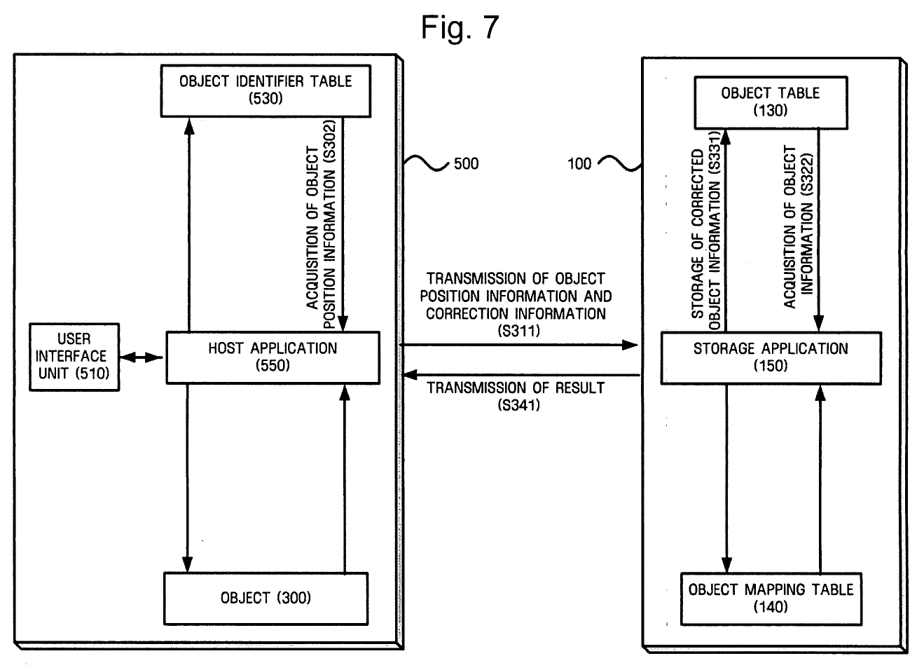

FIG. 7 is a block diagram illustrating a process of allowing the host device 500 to correct an object acquired from the portable storage device 100 according to an exemplary embodiment of the present invention.

When an object read or acquired from the portable storage device 100 should be corrected, the host application 550 can correct or update the object stored in the portable storage device 100. In this case, the host application 550 searches the object identifier table 530 and acquires position information on an object to be read (S302). Then, the host application 550 transmits the position information on the object and corrected information on the object to the storage application 150 (S311). The storage application 150 directly acquires the corresponding object information using the received position information on the object without searching the object table 130 (S322), corrects the content of the object, and stores the corrected content in the object table 130 according to the position information on the object (S331). Alternatively, the storage application 150 may transmit the correction result to the host application 550 (S341).

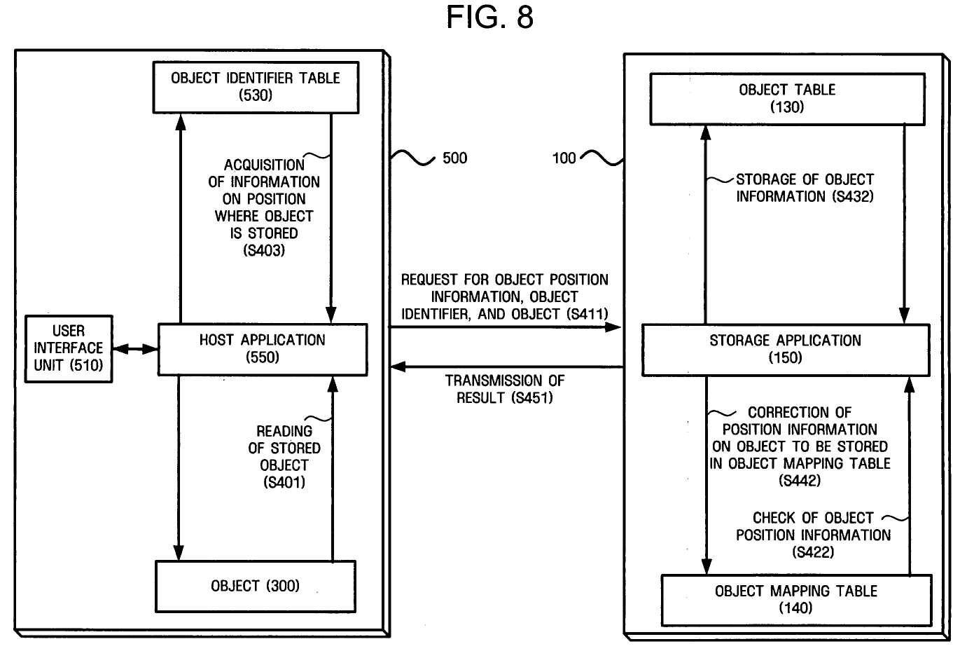

FIG. 8 is a block diagram illustrating a process in which the host device 500 stores an object in the portable storage device 100 according to an exemplary embodiment of the present invention.

The portable storage device 100 can store, correct, and utilize the object mapping table 140. When storing an object, the portable storage device 100 checks the information stored in the object mapping table 140 and can readily determine the status information on the object in use in the object table 130. Even if the object mapping table 140 does not exist, the portable storage device 100 can easily check whether an object is stored in the portable storage device 100 by using the object identifier table 530 provided in the host device 500.

The host application 550 can store an object of the host device 500 in the portable storage device 100. First, the host application 550 reads the stored object (S401). Then, the host application 550 can acquire the position information for storing the object in the portable storage device 100 by using the object identifier table 530 (S403).

The host application 550 transmits the position information on a storage position, the object identifier, and the object to the storage application 150 (S411). The storage application 150 checks the object mapping table 140 using the position information on the object (S422). As a result of this checking, if the position information on the object is valid, the storage application 150 stores the object and the object identifier at the position corresponding to the position information on the object without searching the object table 130 (S432). The storage application 150 corrects the content to give notice that the object is stored at the position corresponding to the position information on the object in the object mapping table 140 (S442). Alternatively, the storage application may transmit the storage and correction results to the host application 550 (S451).

When the object mapping table 140 is not used to store the object, operations S422 and S442 can be omitted.

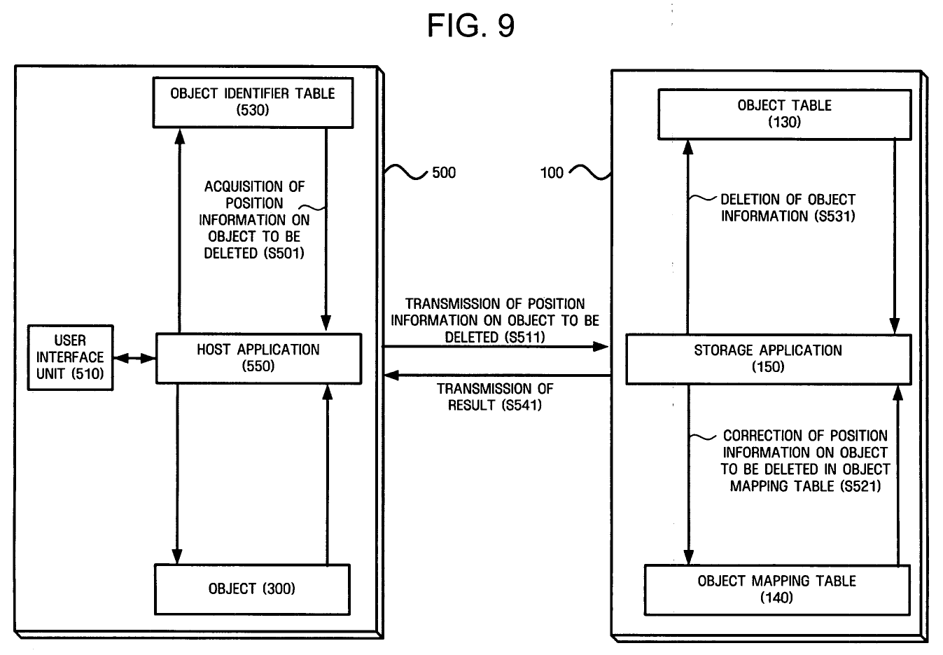

FIG. 9 is a block diagram illustrating a process in which the host device 500 deletes an object stored in the portable storage device 100 according to an exemplary embodiment of the present invention.

First, the host application 550 can acquire position information on an object to be deleted by using the object identifier table 530 (S501). The host application 550 transmits the position information on the object to be deleted to the storage application 150 (S511). The storage application 150 corrects the information in the object mapping table 140 by using the received position information on the object (S521). Accordingly, when a job of reading or correcting the object to be deleted is requested later, it can be notified that the object has been deleted, without searching the object table 130. The storage application 150 directly deletes the corresponding object and object identifiers without searching the object table 130 (S531). Alternatively, the deletion result may be transmitted to the host application 550 (S541).

When the object mapping table 140 is not used to store the position information, operation S521 can be omitted.

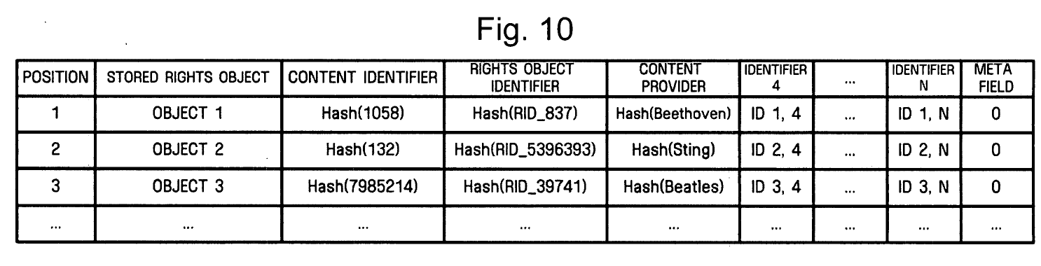

FIG. 10 is a table illustrating examples of objects and object identifiers thereof stored in the object table 130. In FIG. 10, the identifiers transformed by the cryptographic hash function according to an exemplary embodiment of the present invention are stored.

Objects are stored in the object table. Each object may be one rights object and a part of several divisions divided from the rights object. A fixed length can be required for storing an object in the object table. When a rights object has a length greater than the fixed length, the rights object can be divided and stored. The object table indicates that an object can be continuously stored in a storage medium.

Various identifiers can be used to identify an object. In the object table shown in FIG. 10, content identifiers, rights object identifiers, content provider identifiers, etc. serve as the object identifiers. Identifiers of content stored in the host device can be used to retrieve a rights object, or rights object identifiers can be used to retrieve a rights object. Alternatively, composer names or singer names can be used to retrieve a rights object. The object identifiers can have various lengths for use in the retrieval. However, when the identifiers have various lengths, it is difficult to accurately infer the positions where the objects are stored. Therefore, in an exemplary embodiment of the present invention, as described above, the object identifiers can be stored as having a constant length using the cryptographic hash function.

For example, actual content identifiers of objects 1, 2, and 3 have different lengths 1058, 132, and 7985214, respectively. However, the content identifiers may be stored as having the same length by using the hash function. This is also true for the rights object identifiers and the content provider identifiers.

By leaving empty a part of the object identifier fields in the object table, the host device is allowed to create object identifiers, thereby usefully utilizing the object table. For example, in FIG. 10, three identifier fields exist, and the other identifier fields are left empty without establishing identifiers. Thereafter, the host application may establish new identifiers and store the new identifiers in the object table.

According to the exemplary embodiments of the present invention described above, the objects stored in the portable storage device can be rapidly retrieved, thereby enhancing the speed for using an object.

In addition, by applying a cryptographic hash function to the object identifiers, it is possible to more securely manage the object identifier information and obtain the positions of objects in the portable storage device.

While the present invention has been particularly shown and described with reference to exemplary embodiments thereof, it will be understood by those skilled in the art that various changes in form and details may be made therein without departing from the spirit and scope of the present invention. The exemplary embodiments should be considered in a descriptive sense only and not for purposes of limitation. Therefore, the scope of the present invention is defined not by the detailed description of the exemplary embodiments of the present invention but by the appended claims, and all variations and equivalents within this scope will be construed as being included in the present invention.

What is claimed is:

1. A method of retrieving a rights object from a portable storage device using an object identifier, the method comprising:
reading the object identifier stored in the portable storage device;
storing the object identifier; and
retrieving and using the object identifier to perform a job on an object stored in the portable storage device.

2. The method according to claim 1, wherein the object identifier is a value transformed by a cryptographic hash function.

3. The method according to claim 2, wherein retrieving the object identifier includes retrieving identification information on the object using the value transformed by the cryptographic hash function.

4. The method according to claim 2, wherein the cryptographic hash function is a cryptographic hash function employing a private key.

5. The method according to claim 4, wherein retrieving the object identifier includes retrieving identification information on the object using the value transformed by the cryptographic hash function employing the private key.

6. The method according to claim 1, further comprising sharing a session key through mutual authentication with the portable storage device after accessing the portable storage device,
wherein data transmitted to the portable storage device is encrypted using the session key, and data received from the portable storage device is decrypted using the session key.

7. The method according to claim 1, wherein reading the object identifier includes receiving position information on the object indicated by the object identifier.

8. The method according to claim 1, wherein storing the object identifier includes storing the object identifier in a table.

9. The method according to claim 1, wherein the object identifier includes one of identification information on content associated with the object, identification information on use of the object, and identification information on a subject creating the object.

10. The method according to claim 1, wherein the object is a rights object, or part of the rights object, having information on rights to content.

11. The method according to clam 1, further comprising acquiring position information on the object.

12. A method of retrieving a rights object from a portable storage device using an object identifier, the method comprising:
transmitting the object identifier stored in advance in the portable storage device to the host device;
receiving from the host device position information on the object and information on a job to be performed on the object; and
accessing the object and information on the object using the position information.

13. The method according to claim 12, wherein the object and the object identifier are stored in a table.

14. The method according to claim 12, wherein the object identifier stored in advance is a value transformed by a cryptographic hash function.

15. The method according to claim 14, wherein the cryptographic hash function is a cryptographic hash function employing a private key.

16. The method according to claim 12, further comprising sharing a session key through mutual authentication with the host device after accessing the host device,
wherein data transmitted to the host device is encrypted using the session key, and data received from the host device is decrypted using the session key.

17. The method according to claim 12, wherein accessing the object and the information on the object using the position information includes updating the information on the object, if a job to be performed on the object is one of updating, storing, and deleting the object stored in the portable storage device.

18. The method according to claim 12, wherein the object identifier includes one of identification information on content associated with the object, identification information on use of the object, and identification information on a subject creating the object.

19. The method according to claim 12, wherein the object is a rights object, or a part of the rights object, having information on rights to content.
